(19) United States
(12) Patent Application Publication
(10) Pub. No.: US 2011/0035314 A1
(43) Pub. Date: Feb. 10, 2011

(54) Mortgage Program

(75) Inventor: David Bolger, Aurora, IL (US)

Correspondence Address: MICHAEL P. MAZZA, LLC, 686 CRESCENT BLVD., GLEN ELYN, IL, 60137, US

(73) Assignee: Mari Beth Bolger, Aurora, IL (US)

(21) Appl. No.: 12/535,144

(22) Filed: Aug. 4, 2009

(51) Int. Cl. G06Q 40/00; G06Q 30/00

(52) U.S. Cl. 705/38

(57) ABSTRACT

A mortgage plan enabling a customer to enter into a rent-to-own contract with a third-party holding company, in order to enable the customer to purchase an asset such as a home, auto, boat, etc. In lieu of earnest money, the customer may sign a promissory note equal to a predetermined percentage of the purchase price of the home, or a predetermined fixed amount, whichever is greater, for the benefit of the holding company and a loan guarantor. The holding company may contract with a builder to construct the home. A lender may finance the holding company's home purchase with a commercial loan, guaranteed by the loan guarantor. After closing, the customer may move into the home as a renter. A predetermined number of periodic rental payments are made by the customer/renter; from these payments, the guarantor's fee is paid, and the remainder is escrowed. The escrowed funds may then be used as the customer's down payment to purchase the home from the holding company, financed by the lender with a mortgage solely in the customer's name.

### BACKGROUND OF THE INVENTION

The present invention generally relates to mortgage programs. More specifically, the invention relates to a new type of mortgage program in which a third-party holding company acts as the interim buyer.

The residential home building business is believed to have a great impact on our nation's economy. Building a home requires the direct participation of countless workers touching many walks of life and job types. Further, constructing new residences provokes corollary purchases ranging from appliances, automobiles, etc., creating a second and third wave of job formation.

The housing industry has been a significant factor in the strength of the economy. This can be easily seen when analyzing employment histories. In 2005, during the peak of the U.S. housing boom, when more than 2 million homes were built, 2 million new jobs were created and the total number of new workers increased by 2.6 million. The unemployment rate was at 4.9%, down from 5.5% in 2004. Some have even suggested that the housing market prevented a full-scale recession following the dot-com burst of 2001.

By 2007, the housing sector was declining and its ramifications were beginning to take effect in other areas. While wages rose and unemployment remained low, there was a net loss in jobs in construction, manufacturing and education. This was the first time in nearly four years that more jobs were lost than created. Virtually all jobs lost in construction were in the residential market, reflecting the housing market downturn.

In 2009, a mere 500,000 new homes are being built, less than a quarter of what was built in 2005. The unemployment rate increased to 9.5%. In the Chicago area, the rate was 10.4%, an increase from the 6.2% rate posted the prior year. In terms of construction employment, 1.3 million jobs were lost in the U.S. since 2007, with 45,000 lost in Illinois, which was nearly 20% of all construction employees.

Simply put, when the residential construction industry was at its peak in 2005, unemployment was at a record low. Conversely, when construction has halted to less than 25% of its peak, unemployment has skyrocketed. It is believed that if construction can be reinvigorated, laid-off workers will return to work, the unemployment rate will decrease, the economy will return to growth, and demand will be created for the legions of foreclosed homes saturating the market. Given this, it is believed that real estate values will firm and the underpinnings for a prolonged recovery will be in hand.

It is also believed that a key to the sustainability of such a plan is the need for America to re-size its appetite from larger and more opulent homes, to residences that are proportionate to the earning capacity of the purchaser.

A swelling collection of buyers willing to purchase a new home exists among those individuals and couples who were separated from their former residence through the act of foreclosure. Some might believe that this faction's economic difficulties stem from their mismanagement of financial matters and they should therefore be characterized as high credit risks. However, a significant portion of these individuals are victims of the current economic recession and, as a result, are a casualty of fiscal conditions beyond their control. In recent memory, these people would have been considered a responsible credit risk; however, for many, bankruptcy is now the only viable defense against creditors.

By virtue of bankruptcy rules, these constituents are no longer able to fully contribute to the thrust of the nation's economy because they no longer have access to credit. FHA guidelines require those who have filed for Chapter 7 bankruptcy protection to wait a minimum of two years before they can qualify for a home loan.

Many of these prospects have steady income to make mortgage payments but are unable to obtain a new mortgage due to their bankruptcy filing. Mitigating circumstances that should be taken into account when evaluating the financial dependability of these individuals include:
Job loss, but the party has since found stable employment.
Purchased a new home, but they were unable to sell their existing home due to the collapsed real estate market. Incapable of making the dual mortgage payments, they lost both homes to foreclosure.
Bought a home beyond their financial capacity—empowered by predatory lending programs—and were unable to cope with the related payments.
Incurred significant medical expenses, but the impacting health issue has since been made well.

To facilitate these individuals in their desire to purchase a new home, a new mortgage program has been invented, as disclosed here. A major segment of the market inclined to buy a new home today consists of individuals who have lost their residence to foreclosure and have subsequently declared bankruptcy. The mortgage program of the present invention will enable such individuals to buy a new home through the participation of a third-party holding company and a loan guarantor. This new mortgage program will provide the platform for these individuals to buy a new home now, while creating a mechanism to reconstitute their credit, enabling them to finance their purchase at the conclusion of a rent-to-own program having a predetermined time duration.

Unlike a traditional home purchase, in which a customer signs a contract directly with a home builder, the mortgage program of the present invention introduces a third-party holding company as the interim buyer of the residence, who then leases the home to the customer in a rent-to-own equity building program. Instrumental in making this program feasible is the loan guarantor who guarantees the required monthly payments to the lender. These two entities constitute the vehicles which make it possible for a customer who has filed for Chapter 7 bankruptcy protection, for example, to acquire a new home now.

While the preferred embodiment disclosed here focuses on bankrupt individuals, those of ordinary skill in the art will understand and appreciate that this relatively narrow focus may be easily broadened to include other potential buyer demographics not impaired by the financial collapse, such as first time and move-up homebuyers who lack the down payment necessary to purchase a new residence.

### SUMMARY OF THE INVENTION

In one preferred embodiment of the invention, mortgage plan documents are prepared enabling a customer wishing to purchase a home pursuant to a mortgage. The mortgage plan specifies a holding company willing to enter into a contract with a home builder to construct the home, a loan guarantor guaranteeing a loan covering the mortgage, and a lender willing to finance purchase of the home based on the loan. The mortgage plan preferably utilizes a computerized network or standalone workstations along with one or more accompanying software applications and associated hardware as required, to prepare various documents, including: a home building contract between the home builder and the holding company and/or the guarantor in which the home builder agrees to construct the home; a rental agreement through which the customer agrees to pay periodic rental payments constituting either : a predetermined percentage of the purchase price of the home, or a predetermined fixed amount; and a loan, which may be either a commercial or a consumer loan, extended by the lender, enabling at least one of the holding company and the loan guarantor to finance purchase of the home.

The loan guarantor may be either a public or a private entity, assuming relevant laws and security and bank regulations permit this. The loan guarantor and the holding company may even constitute the same entity, or be owned by the same entity. In one alternative embodiment, the public loan guarantor could constitute the federal government, or its agent or agency, in which case the use of a holding company may not be necessary.

The rental payments may be calculated based on various parameters which the parties to the mortgage plan may agree, such as based on principle, interest and real estate taxes payable on the mortgage or, alternatively for example, based on the amount of outstanding loan. A portion of the rental payments may be used to pay the loan guarantor, while the remainder may be escrowed or paid into an equity savings account.

The preferred embodiment contemplates two closings: a first closing at which the holding company and/or guarantor takes title to the home or other asset; and a second closing at which time the portion of the customer's escrowed rental payments forming the equity savings account and not already paid to the guarantor, for example, may be used as a down payment on the purchase price of the home to enable the customer to obtain a mortgage in his/her name on the home.

The customer may execute one or more guarantees for all or some substantial percentage of the purchase price of the home, such as a promissory note and/or pledge of collateral, to induce the guarantor to enter into the transaction.

The home builder may agree to pay at closing periodic amounts equal to a predetermined number of loan payments and related real estate taxes into an escrow account. The rental payments made by the customer may constitute an equity-build account and a portion of the account may be used to pay the guarantor; upon closing, a substantial portion of the account may be used as a down payment to fund a mortgage on the home in the customer's name.

One or more of the documents making up the mortgage plan may specify that if the customer defaults on the rental payments, the loan guarantor may be entitled to one or the following recourses, although each of these recourses may or may not apply depending upon what the parties to the mortgage plan may negotiate: repay the loan; extend the loan terms with the lender; be paid the already-paid-in customer rental payment in the escrowed account; and/or demand payment on the customer guarantees. Additionally, in the event of customer default, the home builder and/or the holding company may, but need not, agree to be responsible for finding an alternative buyer, either as part of the consideration for the original agreement, or for an additional fee.

A method for enabling a customer to make a purchase of a home also forms part of the present invention. The method may utilize a computerized environment of workstations with or without servers and one or more specified software applications, along with the necessary hardware such as printers and monitors, to prepare various documents pursuant to a mortgage plan. The mortgage plan may specify a holding company willing to enter into a contract with a home builder to construct the home, a loan guarantor guaranteeing a loan covering the mortgage, and a lender willing to finance purchase of the home by the holding company using the commercial or consumer loan. The method may include the step of preparing a contract between the holding company and a home builder, in which the home builder agrees to construct the home; the step of preparing a promissory note through which the customer guarantees payment to the holding company of periodic rental payments constituting the greater of: a predetermined percentage of the purchase price of the home, or a predetermined fixed amount; and the step of preparing a commercial or consumer loan extended by the lender, enabling the holding company to finance purchase of the home.

Instead of enabling the purchase of a home, the principles of the present invention may be used to enable a buyer to purchase other items such as automobiles, boats, etc. In this embodiment, a home builder is obviously not used. Instead, the customer agrees to make rental payments for a predetermined period into an equity-build account. A lender finances the loan based on guarantees by a financially sound guarantor. A holding company may or may not be used. A portion of the rental payments may be used to pay the guarantor. At the end of a specified period, a “closing” may be had and the remainder of the equity-build account may be used as the customer's down payment on the asset, and a loan or mortgage for the asset may be executed solely in the customer's name.

### DETAILED DESCRIPTION OF THE PREFERRED EMBODIMENTS

Set forth below is a description of what are believed to be the preferred embodiments and/or best examples of the invention claimed. Future and present alternatives and modifications to the preferred embodiments are contemplated. Any alternatives or modifications which make insubstantial changes in function, in purpose, in structure, or in result are intended to be covered by the claims of this patent.

In a preferred embodiment of the present invention, a rent-to-own/equity savings plan capitalizing on the untapped markets mentioned above may be deployed. In one particularly preferred embodiment, the mortgage plan may be structured to be particularly suited for use by individuals who have filed for Chapter 7 bankruptcy protection. In this embodiment, the customer may enter into a rent-to-own contract with a third-party holding company, with no money down. In lieu of earnest money, the customer may sign a promissory note equal to some predetermined percentage (e.g., 25%) of the purchase price of the home or a predetermined dollar amount (e.g., $100,000), whichever is more, for the benefit of the third-party holding company and a loan guarantor (as further discussed below). On behalf of the purchaser, the third-party holding company may enter into a contract with the home builder to build the customer's residence.

Following a predetermined (e.g., 6-month) design/build time, the third-party holding company may then close on the residence and the customer may move into his or her new home as a renter. Relying solely on the strength of the loan guarantor's balance sheet for security, the lender may then finance all or some portion of the holding company's purchase with a commercial or consumer loan. For the benefit of the loan guarantor, the home builder may agree to fund at closing a predetermined number of loan payments (e.g., the first 16 interest-only loan payments), which may but need not be interest-only, and which may but need not include related real estate taxes, for disbursement into an escrow account. The customer may then be required to make a predetermined number of periodic (e.g. monthly) rental payments (e.g., 16) which may but need not be equal to an (e.g.) 15-year or 30-year fixed mortgage payment for the home, which may include principle, interest and real estate taxes, to the third-party holding company. On behalf of the customer, the third-party holding company may deposit the rental payments it receives from the customer into an equity savings account, less the loan guarantor's fee. The escrow the home builder deposits at the first closing may but need not be based on the interest-only loan payments, for example. From the customer's rental payments a fee may be paid to the loan guarantor (such as 25% of the monthly payments).

In this embodiment, if the customer defaults on making the required rental payments, the loan guarantor may choose to repay the commercial or consumer loan or, alternatively, may choose to extend the loan terms with the lender. The loan guarantor could be entitled to the balance of the equity account and/or could demand payment on the note the customer signed, or require possession of any collateral pledged.

Preferably, at the conclusion of the rental payments made into the equity savings account (i.e., at the time of the second closing), the equity account funds may be used as the customer's down payment to purchase the home from the third-party holding company, financed by the lender with a fixed mortgage solely in the customer's name. Alternatively, the equity account funds could be held by the guarantor, a bank, a title company, or otherwise escrowed.

Customers will be motivated to reconstitute their creditworthiness expediently. To enter into the mortgage plan of the present invention, however, such customers may have to meet stringent underwriting criteria established both by the loan guarantor and the lenders. The loan guarantor's underwriting criteria will likely be more rigorous than those of the lender due to the inherent risk of guaranteeing the commercial or consumer loan for the customer's benefit. Indirectly, then, the lender would be the beneficiary of standards they themselves are prohibited to use, incentivizing lenders to be involved in the mortgage program, as well.

As mentioned above, in a preferred embodiment of the invention, the customer may enter into a rent-to-own agreement with a third-party holding company who will in turn sign a contract with the home builder to construct a home on behalf of the customer. Under the terms of the mortgage plan documents, the holding company may be permitted to close on the property after a predetermined design/fabrication period (e.g., 6 months) and the customer may then move into the new home as a renter. Upon the successful conclusion of a predetermined rent-to-own equity build program (e.g., at the end of a 16-month period following the closing), the holding company may then sell the home to the customer. In the event of a customer default, a distinct advantage of having the holding company possess title to the home is that the cumbersome process of a foreclosure is avoided. Instead, the less unwieldy procedure of evicting the customer from the premises as a renter would pertain.

The third-party holding company may be a shell institution that has no assets. The role of this company is to be the contracting body purchasing the home, and to be the interim title holder after closing. This provides an entity the lender can finance given that the customer cannot qualify for a loan. Instrumental in making this equation feasible is the responsibility of the guarantor who provides security to the venture, making the loan possible. This duty will be detailed in greater depth below.

The result of seeking protection from creditors through Chapter 7 bankruptcy is the forfeiture of one's assets. Having nothing to pledge, the customer's security to enter into the rent-to-own contract comes in the form of a note equal to (e.g.) 25% of the purchase price of the home or (e.g.) $100,000, whichever is greater. If the customer does not make the required equity savings deposits or fails to close on the home, demand can be made on the note by the loan guarantor.

The strength of the promissory note is greatly enhanced because, under existing federal U.S. bankruptcy law, this obligation cannot be discharged through a new bankruptcy filing until the seventh anniversary of the original insolvency ruling. This bolsters the likelihood that the customer will successfully fund its rent-to-own equity build obligation and later close on the home because it is unlikely that the customer will either be able to or will desire to evade the duty to pay the note.

In the preferred embodiment, from the closing proceeds, the home builder may fund an escrow account for the first predetermined number (e.g., 16) of interest-only payments and related real estate taxes. The escrow account may be drawn down to meet the monthly loan obligation until the account is depleted. This provides needed security to the loan guarantor and gives the customer time to establish a down payment.

In lieu of mortgage and tax payments, in the preferred embodiment the buyer/customer may pay rent in like amount to the holding company, who may deposit these funds (less a certain amount, e.g., 25%, to the guarantor) into an equity savings account for the later benefit of the customer. Pursuant to the mortgage plan documents, these funds may be applied toward the purchase of the home as a down payment at the successful conclusion of the (e.g.) 16-month program. The consistent funding of the equity savings plan by the customer will provide the historical record necessary to reconstitute his or her credit, making it possible for a lender to finance the home purchase.

Below is a table demonstrating how, in one example, the escrow account may be calculated based on the amount of money it takes to cover a commercial loan payment for 16 months, assuming a 7% fixed interest rate and a 2.3% tax rate:

Commercial Loan Account

| | | | Monthly | | |
|---|---|---|---|---|---|
| | | Taxes @ | Payment | Plan | Escrow |
| Purchase Price | I @ 7% | 2.3% | (PITI) | Term | Account* |
| $425,000 | $2,479.17 | $814.58 | $3,293.75 | 16 | $52,700.00 |
| $400,000 | $2,333.33 | $766.67 | $3,099.99 | 16 | $49,599.84 |
| $350,000 | $2041.67 | $670.83 | $2,712.50 | 16 | $43,400.00 |
| $300,000 | $1,750.00 | $575.00 | $2,325.00 | 16 | $37,200.00 |
| $250,000 | $1,458.33 | $479.16 | $1,937.49 | 16 | $30,999.84 |

*Escrow account may be dictated by the amount of money it takes to cover (e.g.) the interest-only mortgage payment for 16 months.

The loan guarantor may be a public or a private entity, but must possess the financial capacity to guarantee the repayment of the commercial or consumer loan. It may be willing to assume the risk of guarantor due to: the attractive monthly fee; the fact that no up-front capital is required of it; the fact that the loan payments are prepaid for a predetermined period of time (e.g., 16 months) from the home builder's closing proceeds, the added security derived from the promissory note signed by the consumer; and, finally, the stringent underwriting standards mitigating the risk of customer default. Cumulatively, these attributes adequately diminish the guarantor's exposure, while the compensation is believed to be significant enough to induce its participation.

In the preferred embodiment, the mortgage plan documents would obligate the lender to finance the customer's purchase of the residence from the third-party holding company with an (e.g.) 30-year fixed loan, and to release the loan guarantor from its debt obligations provided the customer successfully completes the (e.g.) 16-month rent-to-own equity savings program. If the customer fails to perform, the loan guarantor may receive all of the monies paid into the equity account, the customer note may become due, and the guarantor may continue to benefit from the prepaid loan payments made from the home builder's closing proceeds. However, preferably the guarantor assumes the responsibility of the indebtedness and, ultimately, the loan payoff.

Taking a specific example from the one preferred embodiment, the table below reflects amounts derived from the customer's rent, which may include: the third party holding company's monthly equity savings deposit; the amount the loan guarantor earns from the monthly fee; and the amount the purchaser would accrue in an equity account, assuming a 7% fixed interest rate with a 30-year term, and a 2.3% tax rate:

Equity Account/Insurance Premiums

| | Monthly | Monthly fee to | | | | |
|---|---|---|---|---|---|---|
| | purchaser | Guarantor | Amount | | | Equity |
| | payments | 25% of | paid into | | Loan | Account |
| | P & I, 7% | P, I & T | Equity | Plan | Guarantor | at End of |
| Purchase Price | & 2.3% Tax | PMT | Account | Term | Earnings | Program |
| $425,000 | $3,642.11 | $910.52 | $2,731.58 | 16 | $14,568 | $43,705 |
| $400,000 | $3,427.87 | $856.96 | $2,570.90 | 16 | $13,711 | $41,134 |
| $350,000 | $2,999.39 | $749.84 | $2249.54 | 16 | $11,997 | $35,992 |
| $300,000 | $2,570.90 | $642.72 | $1,928.17 | 16 | $10,283 | $30,850 |
| $250,000 | $2,142.42 | $535.60 | $1,606.81 | 16 | $8,569 | $25,708 |

Using the loan guarantor's balance sheet as the sole collateral, the lender will preferably fund all or a substantial portion of the third-party holding company's purchase from the home builder with a commercial or consumer loan. After the customer successfully completes the rent-to-own equity savings plan, the lender may then finance the customer's home purchase from the third-party holding company with a fixed mortgage solely in the customer's name.

As noted above, the distinction of financing the holding company's home purchase from the home builder with a commercial or consumer loan in lieu of a mortgage is important. By funding the venture with commercial paper, the restrictive and regulatory nature of home mortgages is avoided. This loan vehicle provides the platform necessary to launch the creative aspects of this plan, and will be particularly attractive to the lender which must otherwise comply with more restrictive (consumer-oriented) regulatory controls. Thus, the lender may be induced to finance the accord, motivated by the relatively high interest rate charged for commercial loans (assuming a commercial and not consumer loan is involved), the transaction's minimal risk mitigated by the loan guarantor, and the prospect of the fees generated from financing the customer's purchase of the home from the third-party holding company.

In the preferred example disclosed here, until depleted, monthly loan payments would continue to be made from the escrow account the home builder funded at closing. The guarantor could choose to renew the loan or pay it off at the conclusion of the loan term. The guarantor would be the recipient of the equity savings deposits made by the third party holding company from the customer's rent. The guarantor could seek redemption of the note. The home builder would be obligated to secure and maintain the residence on behalf of the guarantor while seeking a new purchaser for the property.

In the preferred embodiment, a computerized network and/or standalone workstations and/or servers may be employed, along with one or more accompanying software applications and hardware as required (e.g., printers, scanners, monitors, copiers, etc.) to prepare the documents incident to the mortgage plan, including the home building contract, the commercial or consumer loan, the mortgage, any guarantees (promissory notes, pledge of collateral, etc.), etc. Workstations that may be used incident to preparation of the mortgage plan documents may include: Linux and variants; MacOS; MS-DOS; IBM OS/2 Warp; Unix and variants; Windows NT; Windows 2000; Windows XP and Windows Vista. Servers which may be used may include: Windows Server 2000; Windows Server 2003; and Windows Server 2008.

In conclusion, it is believed that the most powerful tool to combat the economic peril that has engulfed our country is job growth. It is further believed that no other industry is capable of stimulating employment in all sectors of the economy as robustly as homebuilding. The mortgage plan of the present invention may provide the blueprint for un-tethering the force of this industry, and in its wake may come waves of job creation, stabilizing the economy and giving birth to a prolonged expansion.

The above description is not intended to limit the meaning of the words used in the following claims that define the invention. Other systems, methods, features, and advantages of the present invention will be, or will become, apparent to one having ordinary skill in the art upon examination of the foregoing drawings, written description and claims, and persons of ordinary skill in the art will understand that a variety of other designs still falling within the scope of the following claims may be envisioned and used. It is contemplated that these or other future modifications in structure, function or result will exist that are not substantial changes and that all such insubstantial changes in what is claimed are intended to be covered by the claims.

The terms in the following claims are intended to have their broadest meaning consistent with the requirements of law. Where alternative meanings are possible, the broadest meaning is intended. All words used in the claims are intended to be used in the normal, customary usage of grammar and the English language.

I claim:

1. A mortgage plan enabling a customer wishing to purchase a home pursuant to a mortgage, wherein the mortgage plan specifies a holding company willing to enter into a contract with a home builder to construct the home, a loan guarantor guaranteeing a loan covering the mortgage, and a lender willing to finance purchase of the home based on the loan, the mortgage plan utilizing a computerized network or standalone workstations along with one or more accompanying software applications and associated hardware as required, to prepare the following documents:
a home building contract with the home builder in which the home builder agrees to construct the home;
a rental agreement through which the customer agrees to pay periodic rental payments constituting the greater of: a predetermined percentage of the purchase price of the home, or a predetermined fixed amount; and
a loan extended by the lender, enabling at least one of the holding company and the loan guarantor to finance purchase of the home.

2. The mortgage plan of claim 1, wherein the home builder contracts with the holding company to construct the home.

3. The mortgage plan of claim 1, wherein the home builder contracts with the guarantor to construct the home.

4. The mortgage plan of claim 1, wherein the loan comprises a commercial loan.

5. The mortgage plan of claim 1, wherein the loan comprises a consumer loan.

6. The mortgage plan of claim 1, wherein a portion of the rental payments is used to pay the loan guarantor.

7. The mortgage plan of claim 1, wherein the loan guarantor comprises a public entity.

8. The mortgage plan of claim 1, wherein the loan guarantor comprises the federal government or an agent or agency therefor, and the loan guarantor functions as the holding company as well.

9. The mortgage plan of claim 1, wherein the loan guarantor comprises a private entity.

10. The mortgage plan of claim 1, wherein the customer executes a guarantee for some substantial percentage of the purchase price of the home.

11. The mortgage plan of claim 10, wherein the guarantee comprises a promissory note.

12. The mortgage plan of claim 10, wherein the guarantee comprises pledged collateral.

13. The mortgage plan of claim 1, wherein the holding company and the guarantor comprise the same entity or, alternatively, are owned by the same entity.

14. The mortgage plan of claim 1, wherein the rental payments are calculated based on principle, interest and real estate taxes payable on the mortgage.

15. The mortgage plan of claim 1, wherein the loan requires the lender to finance the entire or a substantial portion of the purchase price of the home.

16. The mortgage plan of claim 1, wherein the home building contract is between the home builder and the holding company, and wherein the home builder agrees to pay at closing periodic amounts equal to a predetermined number of loan payments and related real estate taxes into an escrow account.

17. The mortgage plan of claim 1, wherein the rental payments are made during an equity-build period and, upon closing, a substantial portion of those payments are used as a down payment to fund a mortgage on the home in the customer's name.

18. The mortgage plan of claim 1, wherein one or more of the documents comprising the mortgage plan specify that if the customer defaults on the rental payments, the loan guarantor is entitled to repay the loan or to extend the loan terms with the lender.

19. The mortgage plan of claim 1, wherein one or more of the documents comprising the mortgage plan specify that if the customer defaults on the rental payments, the loan guarantor is entitled to at least a portion of the rental payments already made.

20. The mortgage plan of claim 10, wherein one or more of the documents comprising the mortgage plan specify that if the customer defaults on the rental payments, the loan guarantor is entitled to demand payment on the customer guarantee.

21. The mortgage plan of claim 1, wherein upon final payment by the customer of the predetermined number of periodic rental payments, one or more of the documents comprising the mortgage plan specify that the escrowed rental payments may be used as a down payment enabling the customer to purchase the home, financed by the lender with a mortgage in the customer's name.

22. A method for enabling a customer to make a purchase of a home, the method utilizing a computerized environment of workstations with or without servers and one or more specified applications, along with the necessary hardware such as printers and monitors, to prepare the following documents pursuant to a mortgage plan, the mortgage plan specifying a holding company willing to enter into a contract with a home builder to construct the home, a loan guarantor guaranteeing a loan covering the mortgage, and a lender willing to finance purchase of the home by the holding company using the commercial loan, the method comprising the steps of:
preparing a contract between the holding company and a home builder, in which the home builder agrees to construct the home within a predetermined period of time;
preparing a promissory note through which the customer guarantees payment to the holding company of periodic rental payments constituting the greater of: a predetermined percentage of the purchase price of the home, or a predetermined fixed amount; and
preparing a commercial loan extended by the lender, enabling the holding company to finance purchase of the home.

23. A loan or mortgage plan enabling a customer to purchase an asset, wherein the mortgage plan specifies a loan guarantor guaranteeing a loan for the asset, and a lender willing to finance purchase of the asset based on the loan, the mortgage plan utilizing a computerized network or standalone workstations along with one or more accompanying software applications and associated hardware as required, to prepare the following documents:
a rental agreement through which the customer agrees to make periodic rental payments constituting the greater of: a predetermined percentage of the purchase price of the asset, or a predetermined fixed amount; and
a loan extended by the lender, enabling the loan guarantor to finance purchase of the home.

24. The loan or mortgage plan of claim 23, wherein a portion of the rental payments are used to pay the guarantor, and wherein on completion of the rental payments, the remainder of the payments are used as a down payment by the customer for the customer's purchase of the asset.
